(19) United States
(12) Patent Application Publication
(10) Pub. No.: US 2018/0171779 A1
(43) Pub. Date: Jun. 21, 2018

(54) STEAM QUALITY MEASURING DEVICE

(71) Applicant: Geomax Energy Systems LLC-Oman, Muscat (OM)

(72) Inventor: Salim Saif Basher Al Salmi, Muscat (OM)

(73) Assignee: Geomax Energy Systems LLC - Oman, Muscat (OM)

(21) Appl. No.: 15/577,899

(22) PCT Filed: Jun. 6, 2016
(86) PCT No.: PCT/EP2016/062812

§ 371 Date: Nov. 29, 2017

(30) Foreign Application Priority Data
Jun. 5, 2015 (EP) 15170795.7

(51) Int. Cl. E21B 47/06; E21B 43/24; E21B 47/12

(52) U.S. Cl. CPC E21B 47/06; G01N 25/60; E21B 47/124; E21B 43/24

(57) ABSTRACT

The invention relates to a down-hole device for measuring steam flow and quality in a well, said device comprising an elongate tube-like housing, a power supply, a spinner arranged at the down-hole end of the housing, two pressure sensors arranged at a distance h to each other at the periphery of the housing, and data storage means.

The invention relates to a down-hole device for measuring steam flow and quality in a well.

The evaluation of fluid flows within a well bore is a frequently encountered problem in the oil and gas production industry. There are a number of different flow regimes including multi-phase fluid flows. Factors influencing the flow to regimes can include a degree of borehole deviation and proportion of the phases, relative differences in phase densities, surface tension and viscosity of the phases as well as velocity, pressure and temperature.

Understanding the fluid flow regime in a well may be used to understand the performance of a production well. A production log records one or more in-situ measurements that describe the nature and behavior of fluids in or around the borehole during a production operation, including an injection operation. Production logs can provide for example information about dynamic well performance and the productivity or injectivity of different zones. This information may be used to help diagnose problem wells or monitor the results of a stimulation or completion.

Steam injection is a means that is frequently used to stimulate and enhance oil production from subsurface reservoirs. For operation of a well stimulated by steam injection it is essential to know the steam quantity injected into the reservoir and the steam quality reaching the reservoir. The steam quality is defined as the ratio of vapor mass to total mass of vapor and liquid.

Steam injection is used, for example, in heavy oil reservoirs to raise the oil temperature and reduce its viscosity. It is essential, that a high percentage of the steam reaches the reservoir. However, a certain degree of heat loss to the surrounding formation is inevitable on the way down-hole, this resulting in the conversion of steam into liquid water.

A certain degree of heat loss certainly is tolerable. However, for the commercial performance it is essential that a high percentage of the injected steam reaches the reservoir and transfers its heat to the oil contained therein. It is therefore important to have knowledge of the quality (percentage) of steam that reaches to the reservoir.

The quality of the steam at the time of injection into the well is known—100% of the injected fluid is steam. Hence, the quality is 1.0 by definition.

The quality of the steam decreases with its way down-hole due to transfer to the surrounding formations. At the entrance to the reservoir, the quality is 1.0-x, where x is the fraction of liquid water divided by total fluid (liquid water plus steam).

The normal way for steam quality evaluation is by measurement of pressure, temperature and mass flow and comparing the data obtained with experimental data contained in diagrams and tables. However, down-hole conditions mostly are not ideal so that such estimations do not necessarily correspond to reality.

From WO 2012/085 770 A1 an apparatus and a method for generating steam quality data is known that, among others, relies on flow data obtained from a spinner system. Flow data obtained from spinner systems are influenced by many parameters and not reliable.

It is an object of the present invention to provide a system that allows to calculate steam quality data in a well from down-hole measurements that are highly reliable.

According to the invention, a well regularly is a hydrocarbon (production) well. This includes oil wells, in particular oil wells for the production of heavy oils.

It has been found that pressure data can be obtained with high reliability. Pressure data allow the calculation of steam quality data with high precision from few measurements only. Such measurements can be obtained by means of a probe equipped with the necessary sensors.

Accordingly, the present invention relates to a down-hole device for measuring steam flow and quality in an oil well comprising an elongate tube-like housing, a power supply, a spinner arranged at the down-hole end of the housing, pressure to sensors arranged at a distance h to each other at the periphery of the housing, and data storage means.

In particular, the device of the present invention comprises a down-hole device for measuring steam flow and quality in a hydrocarbon well, that device comprising

an elongate tube-like housing,
a power supply arranged in the housing,
at least one spinner arranged at the down-hole end of the housing, the spinner being arranged in a cage,
two pressure sensors arranged at a distance h to each other at the periphery of the housing, and
data storage and processing means powered by the power supply and designed to process and store pressure and differential pressure data obtained from the pressure sensors.

The device or tool of the invention has the form of an elongate tube, which may have a diameter of e.g. 4 to 8 cm and a length of 2.0 to 5.0 m. At the distal end of the device, i.e. at the down-hole end, there is at least one spinner, which is designed to measure the fluid flow velocity. From the flow velocity, the steam input into the well and the active diameter of the well, approximate data for the mass flow and the steam quality can be calculated.

Preferably, there are arranged two spinners at a distance, coaxially with the device.

The spinners are protected by cages or baskets, which allow free entrance of the surrounding fluids. They allow measurement of the fluid velocity and viscosity, however, also and primarily are to mix the surrounding fluid phase, which consists of high-pressure steam and water, in order to obtain reliable data on the steam quality.

The spinners are preferably located at the distal and proximal end of the device (up-hole and down-hole end). The arrangement allows a constant flow along the sides of the device, which is beneficial for the measurements. The proximal spinner may also be located between the proximal end and the up-hole pressure sensor.

Preferably, the cages have a larger diameter than the device. This keeps the device at a distance from the wall of the well and ensures a fluid flow on all sides of the device. The spinners inside the cages may have a diameter larger than the device for a thorough mixing effect.

The tube-like housing comprises the power supply of the device and the data storage means, where the data from the spinner(s) and the sensors of the device are stored and possibly processed. The power supply preferably is a conventional battery. The housing itself is generally closed, not providing a passage for fluid over its length. However, there may be inlets and outlets for fluid up-hole from one more sensors for mixing and homogenization of the fluid (steam and water).

The tube-like housing may comprise motor for driving the spinner(s), the motor being coupled to the spinner(s). For a viscosity measurement, the power consumption of at least one spinner is measured. The power consumption is an indicator for the viscosity of the surrounding fluid, a high power consumption standing for a high viscosity.

The data obtained by the measurements may be processed and stored with in the device in data processing and storage means. Without telemetric transmission up-hole, the device has to be hauled out of the well for evaluation. Therefore, according to one embodiment of the invention, the device comprises a telemetric transmission system for realtime transmission of the retrieved data to a control center up-hole, e.g. by a transmission cable. This allows to monitor and control the steam feeding process in accordance with the retrieved steam to quality data.

The data storing means also comprises the data for the operation of the sensors and the spinner(s).

The housing comprises at its periphery two pressure sensors, which are arranged at a distance h to each other. The pressure sensors are conventional ones for detecting high pressures in a high temperature environment. Separation of the sensors is necessary in order to detect and measure pressure differences at two different measuring points. The distance should not be too small, but be in the range of about 0.60 to 2.40 m and preferably in the range of about 1.50 to 2.00 m.

In addition, the device of the invention may comprise two temperature sensors, which are also arranged at a distance h. The distance h between the temperature sensors should be the same as with the pressure sensors. Preferably, the pressure and temperature sensors are at the same location of the device so that the pressure data obtained can be linked to the temperature at the measuring location.

Conventionally, down-hole rates are estimated on the basis of spinner data. The spinner is measuring the number of revolutions, which can be calibrated to give the flow rates. Steam input flow rates and measured flow rates down-hole can be used to calculate the steam quality. However, spinner data are not very reliable, as indicated previously.

According to the invention, more precise data can be obtained from pressure measurements, according to the following equations:

$$DHSQ = \frac{Mv}{Ml + Mv} \qquad ( 1 )$$

DHSQ: Steam Quality, ratio.

Mv: Vapor Mass

Ml: Liquid Mass

Conversion of this equation results in equation (2) as follows:

$$DHSQ = 1 - \frac{[ \frac{Δ P π {r}^{2}}{9} ]}{MOWE} \qquad ( 2 )$$

ΔP: Pressure Difference, P2−P1

g: Gravity

MOWE: Mass Of Water Equivalent=Mv+Ml

r: effective radius between pipe internal diameter and tool outside diameter

From equation (2) results, that pressure difference and steam quality are linked and the pressure difference can be used to calculate the steam quality.

The present device gives steam quality data via two individual methods, namely by conversion of spinner data and pressure difference data. Sensored pressure data are closely linked to the temperature, measuring the temperature at the site of the pressure sensor therefore may be important. However, normally the temperature difference between the two measuring points will not be great.

The present device is a high temperature device which allows measuring the relevant down-hole data at temperatures up to 400° C. and pressures up to 1 kbar. It is self understanding that the materials, the device and its components are made from materials that are resistant over the whole temperature and to pressure range.

The device of the invention will be lowered into a well by means of a cable, in a known technology. It may be equipped with distance elements in order to keep a constant distance to the inner wall of the well. The distance elements may be part of the spinner cages or the cages themselves.

The invention further covers a down well steam quality determination probe, as described in detail above and the use of such device and probe for determining the quality of steam injected into a hydrocarbon well.

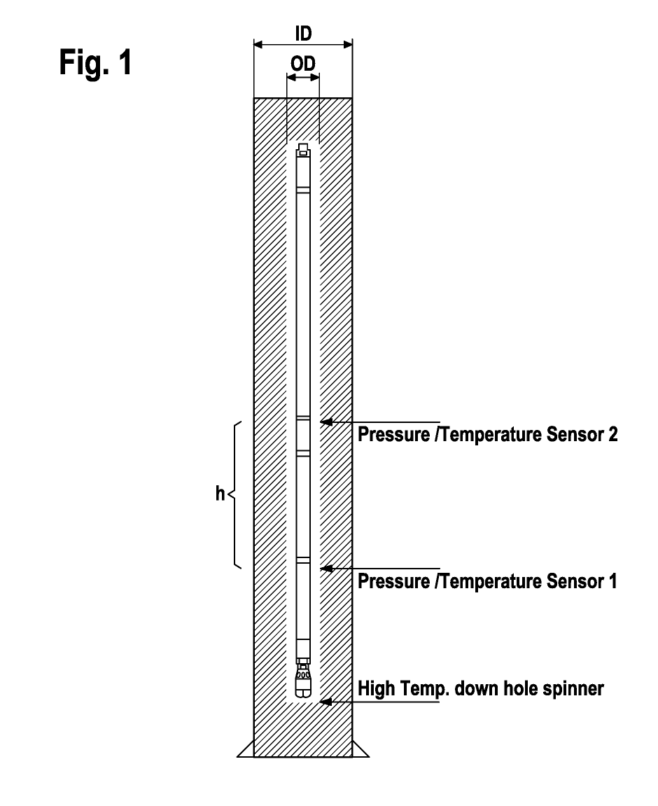

FIG. 1 shows a down-hole measuring device according to the invention, where the tube-like housing has a diameter of approximately 5 cm and a length of approximately 3.50 m. The device comprises a high temperature down-hole spinner head at its down-hole end. The spinner is located in a cage, which provides protection against contact with the wall of the well. The tube-like housing comprises a battery, a motor, a data storage unit and two sensors each for pressure and temperature at a distance h. h is in the range of approximately 1.50 m.

The tool is attached to a cable, which is designed to lower the device into a well which is flooded with high pressure high temperature steam.

ID is the inner diameter of the well, OD the outer diameter of the device with attached cages for two spinners (not shown).

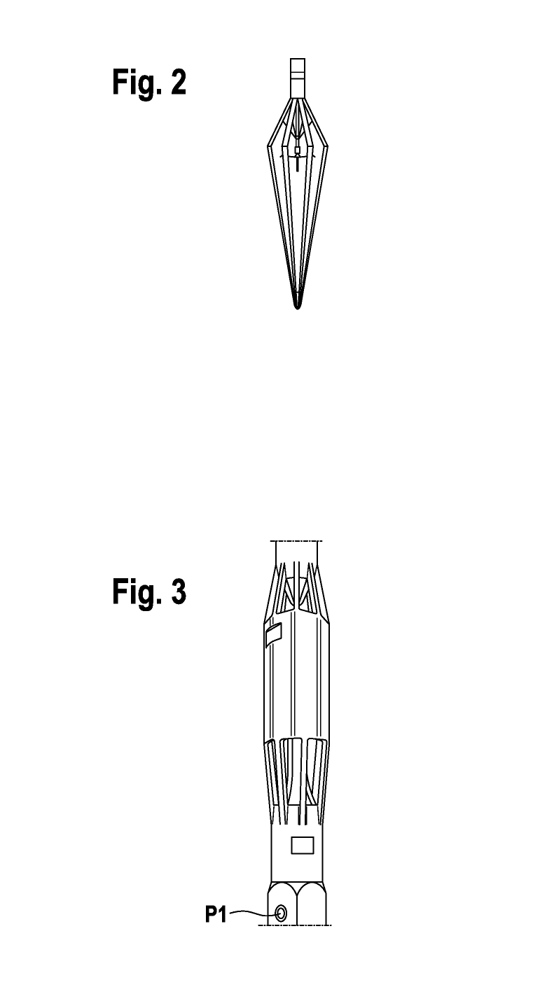

FIG. 2 shows details of the device of the invention, namely a spinner head in a cage, the cage determining the outer diameter OD of the device. As can be seen, the spinner rotates will in the cage, either driven by the flow of the surrounding fluid—which allows the determination of flow rates by conventional methods—or by a motor powered by the power supply. P1 and P2 indicate the location of down-hole (P1) and up-hole (P2) pressure sensors, see FIG. 1.

A similar spinner may be arranged at the up-hole end of the device.

FIG. 3 shows a fluid mixing element integrated into the device up-hole (P2) of a or each pressure sensor. Fluid enters the element through the small upper openings, passes through the tube-like middle section and leaves through the long openings in direction of the pressure sensor (P2). Inside the element there may be located a spinner, the surrounding structure forming a cage.

1. A down-hole device for measuring steam flow and quality in a hydrocarbon well, said device comprising
an elongate tube-like housing,
a power supply,
at least one spinner arranged at the down-hole end of the housing in a cage,
two pressure sensors arranged at a distance h to each other at the periphery of the housing, and
data processing and storage means, powered by the power supply and designed to process and store pressure and pressure difference data obtained from the pressure sensors.

2. The device of claim 1, characterized by two temperature sensors arranged at a distance h to each other.

3. The device of claim 2, wherein the pressure and temperature sensors are each separated by the same distance h.

4. The device of claim 2, wherein the pressure and temperature sensors are at the same location at the periphery of the device.

5. The device of, claim 1 wherein the distance h is 0.60 to 2.40 m.

6. The device of, claim 1, characterized by two spinners, the spinners being mounted at the down-hole and the up-hole ends of the device in cages.

7. The device of claim 6, wherein the spinners rotate around the central axis of the device.

8. The device of claim 7, wherein the device comprises a motor for driving at least one spinner.

9. The device of claim 6, wherein the cages have a diameter exceeding the diameter of the device.

10. The device of, claim 1, characterized in that the power supply is a battery located at the rear end of the housing.

11. The device of, claim 1, characterized in that the storage means are means for storing pressure data from the pressure sensors, flow data from the spinner and temperature data from the temperature sensors.

12. The device of, claim 1, characterized by a connector to a cable for being lowered into an oil well.

13. The device of, claim 1, characterized by a telemetric data transfer to a control center at the surface.

14. A steam quality determination probe according to, claim 1.

15. Use of the device of, claim 1 for determining the steam quality in a hydrocarbon well.
